(19) United States
(12) Patent Application Publication
(10) Pub. No.: US 2011/0157925 A1
(43) Pub. Date: Jun. 30, 2011

(54) ENERGY-SAVING POWER CONVERTER HAVING SUSPEND MODE

(75) Inventor: Kuan Chun Wang, Taipei (TW)

(73) Assignee: Kerio Technologies, Inc, Taipei (TW)

(21) Appl. No.: 12/947,828

(22) Filed: Nov. 17, 2010

(30) Foreign Application Priority Data
Dec. 31, 2009 (TW) 98146244

(51) Int. Cl. H02M 3/335

(52) U.S. Cl. 363/21.17

(57) ABSTRACT

The present invention relates to an energy-saving power converter having a suspend mode. The power converter includes an output port for being electrically connected to the electricity consuming device; a voltage-transforming unit for outputting an output voltage appropriate to the needs of the electricity consuming device; a sensor for assessing the electricity consuming mode of the electricity consuming device, and a switch for selectively determining whether the sensor is to be powered. A wake-up unit is further provided to generate a wake-up signal for activating the voltage-transforming unit to provide power normally. The invention therefore solves the problem of unnecessary energy consumption resulted from a constant voltage conversion during the course when the electricity consuming device need not be supplied with power.

### FIELD OF THE INVENTION

The present invention relates to an energy-saving power converter, and more particularly, to an energy-saving power converter that has a suspend mode and can be waked up when it needs to provide power.

### DESCRIPTION OF THE RELATED ART

As energy saving has become a social consensus, many electricity consuming devices, such as a personal computer, are designed to possess a function of being automatically placed in a standby or suspend mode where the electric power is consumed at a minimum level, when the devices have been idle for a period of time. The personal computer would remain in the state until it is “waked up” by a user's touch on a computer mouse or a key on the keyboard and resumed to a normal operation state, thereby achieving the energy-saving purpose.

As shown in FIG. 1, a conventional power converter 3 includes a plug 31 adapted for coupling to a wall socket 2, a converter body 30 for converting the alternating-current (AC) power taken from the wall socket 2 into a direct-current (DC) power at a voltage level appropriate to the needs of an electricity consuming device 1 to be powered, such as a computer, and an output port 35 for transmitting the converted power to the electricity consuming device 1. Further referring to FIG. 2, the converter body 30 includes inductance coils 33. The converter body 30 is provided with a so-called primary side circuit 32 which extends from the plug 31 to the inductance coils 33. Taking advantage of the electromagnetic induction effect, the voltage coming from the primary side circuit 32 is modulated by the inductance coils 33 as a function of the turns ratio of a primary coil 331 to a secondary coil 332 and transmitted to a secondary side circuit 34 connected to the output port 35. The converted voltage is output after being rectified and filtered.

Since power sockets are normally located around corners of a room or on wall areas under a desk, quite a few users are reluctant to pull out plugs from the sockets when electricity consuming devices are not in use. As a result, even if a laptop computer is put in a standby mode for saving energy, the accompanying power converter will still take power from a wall socket and the inductance coils keep converting the AC voltage at the primary side into another voltage at the secondary side. However, the converted energy is wasted and dissipated into the atmosphere in the form of heat energy, as the output port does not provide power at this moment.

In other words, the primary side circuit 32 and the secondary side circuit 34 in the above case are both placed in the power-consuming and heat-generating state, which is contrary to the original object of power saving. Furthermore, keeping a power converter in continuous operation may result in a shortened lifespan of the power converter. Efforts should be made to effectively halt the operation of a power converter when it need not supply power. It should be understood that the mere interruption of the secondary side circuit 34 is rather insufficient to achieve the energy-saving purpose, and that the primary side circuit 32 is a more appropriate target to be interrupted for the purpose of preventing the primary side circuit 32 and the inductance coils 33 from continuously consuming energy. However, an additional problem arises as to how the power converter, after the primary side circuit 32 is interrupted, can be brought back to provide power to the electricity consuming device 1 when a user returns to operate the electricity consuming device 1.

Therefore, there exists a need for a power converter that can be placed in an energy-saving state in response to an inactive mode of an electricity consuming device to which it is connected, thereby effectively saving the energy consumption. The power converter can also be resumed to a normal operating state in response to an active mode of the electricity consuming device. The power converter can thus satisfy the customers' needs and provide a potent solution to energy-saving and carbon reduction.

### SUMMARY OF THE INVENTION

Accordingly, an object of the present invention is to provide an energy-saving power converter having a suspend mode, whose inductance coils and secondary side circuit will stop consuming energy when an electricity consuming device to which it is connected is placed in a non-working state.

Another object of the invention is to provide an energy-saving power converter having a suspend mode, which has a wake-up device for bringing the power converter back to a normal operating state when an electricity consuming device to which it is connected is resumed to a working state.

It is still another object of the invention to provide an energy-saving power converter having a suspend mode, whose energy-saving function can be switched ON or OFF according to user's choice.

The present invention therefore provides an energy-saving power converter having a suspend mode for providing electric power to an electricity consuming device having at least two electricity consuming modes, including a working mode and a non-working mode. The power converter has a suspend mode corresponding to the non-working mode of the electricity consuming device and a normal operating mode corresponding to the working mode of the electricity consuming device. The power converter comprises an output port for being electrically connected to the electricity consuming device; a voltage-transforming unit having a controller and adapted for outputting at least one predetermined output voltage via the output port; a processing unit, which includes a sensor to be powered by the voltage-transforming unit and adapted for detecting the electric power to be output via the output port to assess the electricity consuming mode of the electricity consuming device, thereby deactivating the voltage-transforming unit, and a switch for selectively determining whether or not the sensor is to be powered; and a wake-up unit for activating the deactivated voltage-transforming unit upon receipt of a mechanical powering signal derived from outside of the power converter.

Since the energy-saving power converter having a suspend mode disclosed herein is provided with a switch, a user may determine whether or not the power converter performs an energy-saving function. In the case where the energy-saving function is carried out, when the electricity consuming device is placed in the non-working state, the sensor provided in the processing unit will detect a significant decrease in energy consumption, thereby deactivating the voltage-transforming unit. As a result, the electrical current in the primary side circuit is stopped flowing to the primary coil, so that the inductance coils and the secondary side circuit stop working and consuming energy. When the electricity consuming device is resumed to the working state, the user may provide an external mechanical powering signal for driving the wake-up unit to activate the voltage-transforming unit. As a result, the inductance coils are resumed to operate and provide electric power to the secondary side circuit, whereby the power converter is waked up from a suspend mode to a normal operating mode.

The wake-up unit is electrically connected to the input port and powered by the input voltage. The wake-up unit is further provided with an actuation sensor or a micro power generator for generating a wake-up signal. The processing unit further includes a memory device, in which a predetermined threshold value for the electricity consuming mode is stored and serves as a standard for the assessment of the electricity consuming mode of the electricity consuming device by the sensor when the sensor is powered.

In addition, the energy-saving power converter disclosed herein would automatically discontinue the voltage conversion, if the electricity consuming device is put in a standby mode. The invention therefore prevents the unnecessary energy consumption resulted from a constant voltage conversion during the course when the electricity consuming device need not be supplied with power. The invention can save energy and successfully achieve the objects described above.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is schematic view of a conventional power converter to be connected to an electricity consuming device;

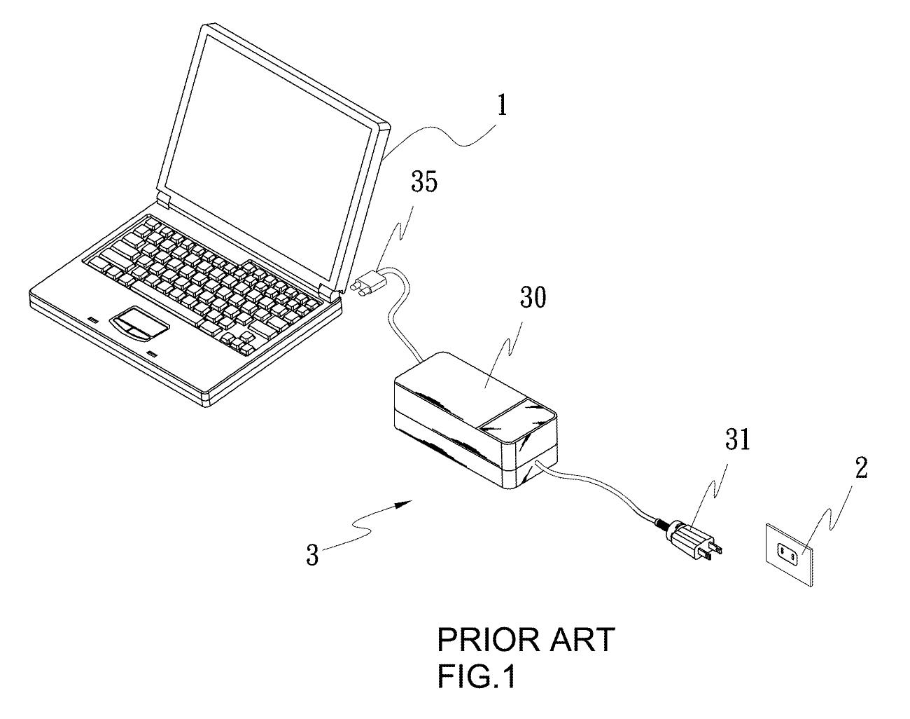

FIG. 2 is an internal circuit diagram of the conventional power converter shown in FIG. 1;

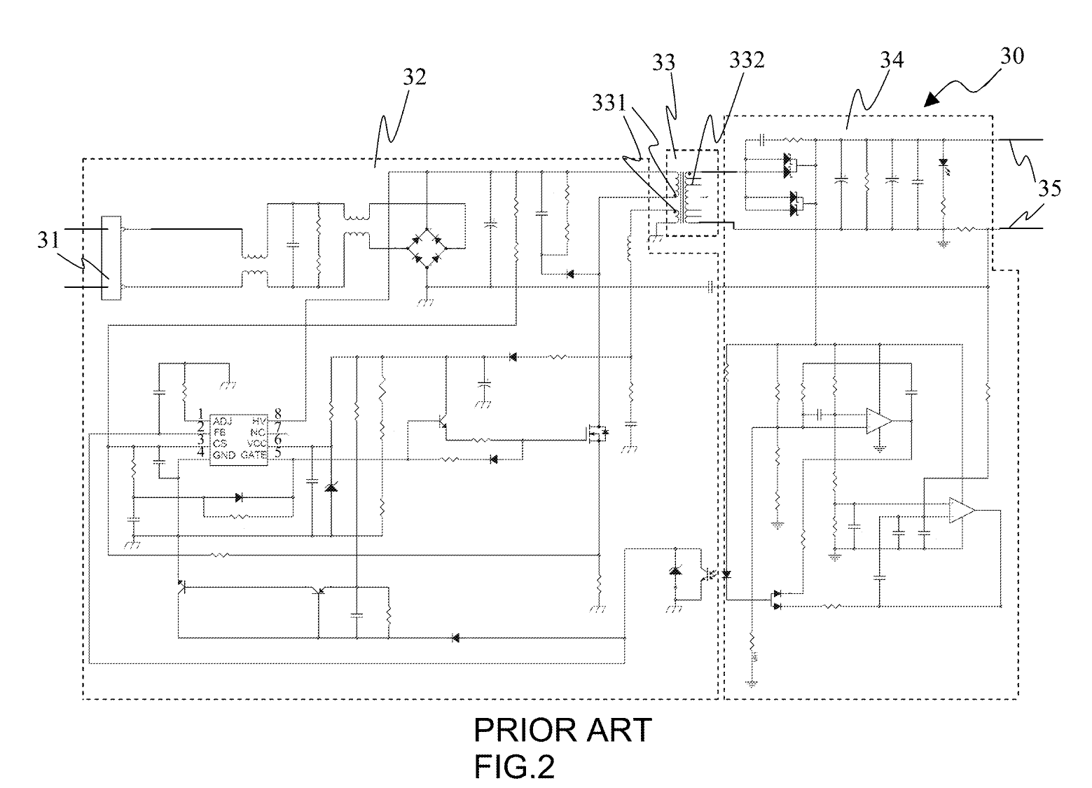

FIG. 3 is a schematic view of an energy-saving power converter having a suspend mode according to the first preferred embodiment of the invention, in which the power converter is to be connected to an electricity consuming device;

FIG. 4 is an internal circuit diagram of the energy-saving power converter having a suspend mode as shown in FIG. 3;

FIG. 5 s a schematic view of a power converter according to the second preferred embodiment of the invention, in which the power converter is to be coupled to a mobile phone;

FIG. 6 is a schematic diagram of the third preferred embodiment of the invention, showing a micro power generator designed to generate a wake-up signal in response to a shaking motion;

FIG. 7 is a circuit diagram according to the fourth preferred embodiment of the invention, in which a three-dimensional orientation sensor is provided for generating a wake-up signal; and

FIG. 8 is a circuit diagram according to the fifth preferred embodiment of the invention, in which a voltage-transforming unit is provided for performing voltage conversion by adjusting the duty-cycle ratio.

### DETAILED DESCRIPTION OF THE INVENTION

For illustrative purpose, an energy-saving power converter having a suspend mode according to the invention may by way of example be suitable for receiving a mains voltage and converting the mains voltage to a voltage level appropriate to the needs of an electricity consuming device to be powered. Alternatively, the power converter according to the invention may be adapted for being connected to an automobile or an aerial vehicle and may even be built-in with a rechargeable battery for providing power to an electricity consuming device.

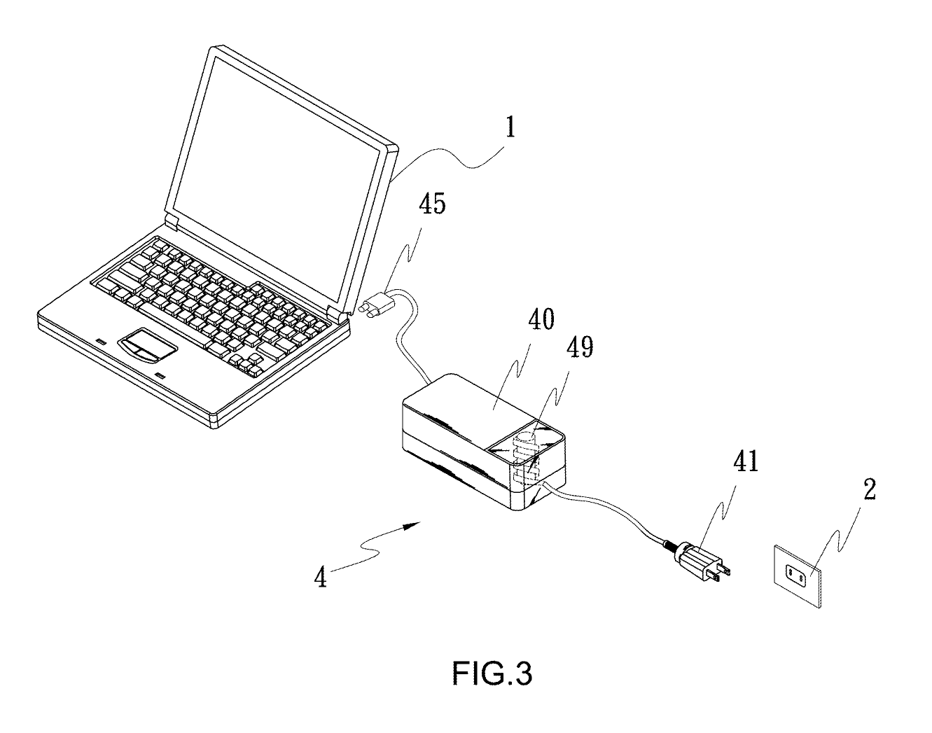

As shown in FIG. 3, a power converter 4 according to the first preferred embodiment of the invention is adapted to provide power to an electricity consuming device 1 which may by way of example be a laptop computer. The power converter 4 has an input port 41 for receiving an incoming voltage from a socket 2. The incoming voltage is transmitted to a voltage transforming unit 40, at which the incoming voltage is converted into a predetermined output voltage to be provided to the electricity consuming device 1 through an output port 45.

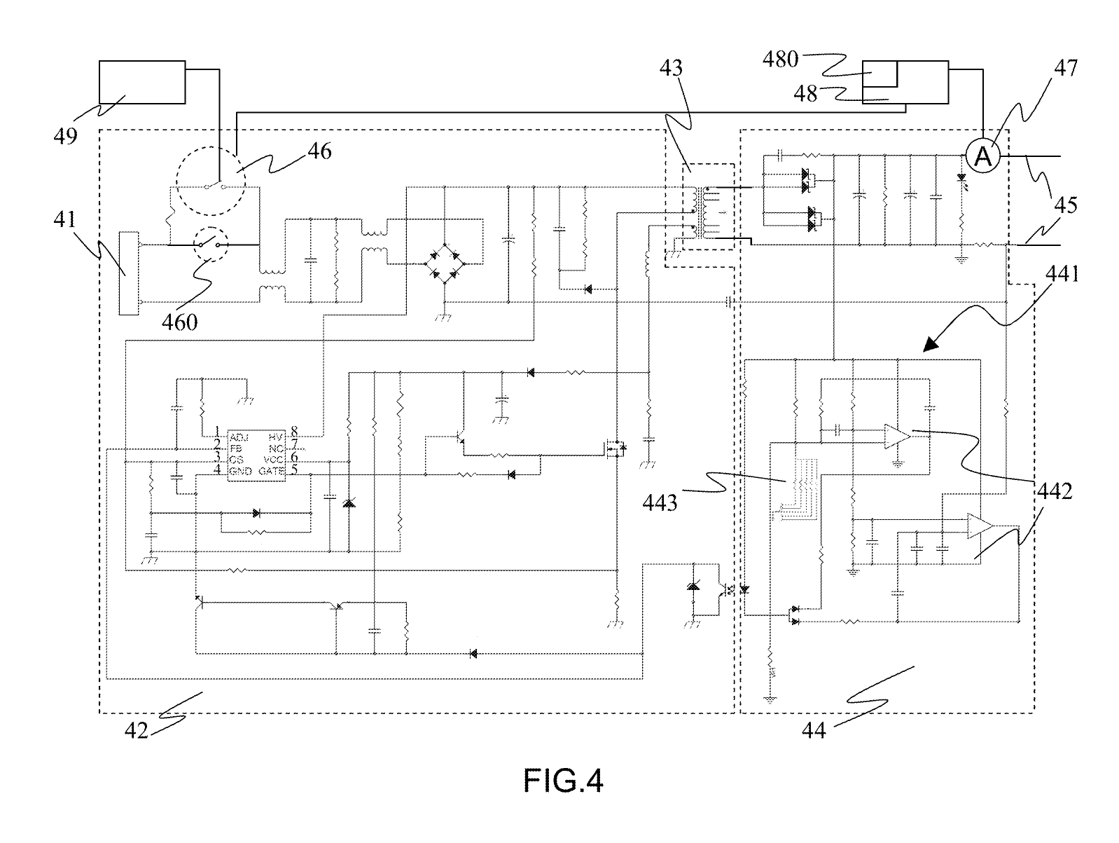

As shown in FIG. 4, according to this embodiment, a sensor 47, which may by way of example be a galvanometer, is coupled between a secondary side circuit 44 and an output port 45. The sensor 47 is controlled by a switch 460 which may by way of example be a tumble switch. That is to say, a user may determine whether or not the power converter 4 performs an energy-saving function by simply pressing the switch 460. If the user presses the switch 460 to place the power converter 4 in the energy-saving mode, the sensor 47 would be powered and activated to detect an output current to be passing through the output port 45, thereby assessing the level of electric power supplied to the downstream electricity consuming device 1.

When the sensor 47 detects that the amount of the output current passing through the output port 45 has been significantly reduced to a level lower than a predetermined threshold value stored in a memory device 480 of a processing unit 48 for a period of time, a relay 46 provided in a primary side circuit 42 is driven to be in an electrically disconnected state. As a result, the primary side circuit 42, inductance coils 43 and the secondary side circuit 44 will not be provided with power, so that the power converter 4 is placed in a suspend mode in accordance with the non-working state of the electricity consuming device 1, thereby significantly reducing the power consumption. In addition, the power converter 4 according to the embodiment is equipped with a micro power generator 49 as a wake-up device, which is produced by winding a power line connected to the input port around a rotor portion of the micro power generator 49.

In the case where the power converter 4 is put in the suspend mode, if a user wants to turn on a computer connected thereto, he could simply draw the power line a little bit to generate an external mechanical signal, so that the rotor of the micro power generator 49 is rotated with respect to the housing of the power converter 4 and a stator of the micro power generator 49. As a result, a tiny amount of electricity is generated to serve as a wake-up signal for placing the relay 46 in an electrically connected state, thereby activating the primary side circuit 42. The power converter 4 is consequently switched from the suspend mode to a normal operating mode in accordance with the working state of the electricity consuming device 1 which allows power to be supplied to the electricity consuming device 1. The rotor of the micro power generator 49 is further provided with a spring for retracting the power line back to the wound position for subsequent use.

According to this embodiment, a voltage transforming unit 441 is provided and illustrated as one capable of providing different output voltages, in which transforming circuits 442 are provided to convert an input voltage fed to the input port 41 into one of a plurality of predetermined output voltages. Upon receipt of a command from the processing unit 48 in accordance with a detected result by the sensor 47, a selector 443 selectively places one of the transforming circuits in an electrically connected state, thereby selecting one of the plurality of predetermined output voltages which is appropriate to the needs of the electricity consuming device 1, and the selected output voltage is then provided to the electricity consuming device 1 via the output port 45. It should be noted that if the user decides not to allow the power converter 4 to perform an energy-saving function, the sensor will not be activated and the relay will remain in an electrically connected state. At this moment, the power converter according to the invention is used in a manner equivalent to the way that its conventional counterparts are used.

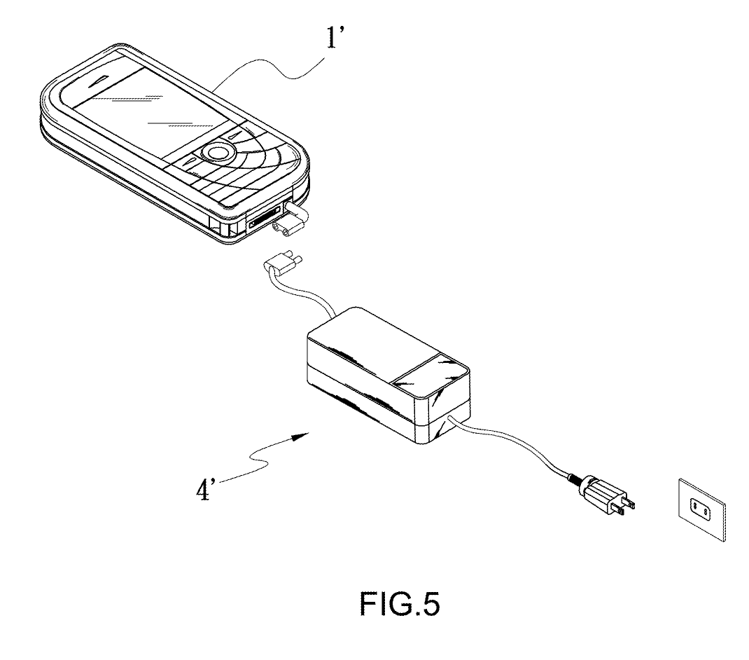

It will be readily apparent to those skilled in the art that the electricity consuming device is not limited to the computer described in the embodiment above, but also includes any devices that consume electricity and have a working state and non-working state, such as a mobile phone or an MP3. As shown in FIG. 5, during the course of being charged by a power converter 4′, a mobile phone 1′ is placed either in a working state where the mobile phone 1′ is being charged, or in a non-working state where the mobile phone 1′ is fully charged. When the power converter is tailored according to the needs of a specific model of an electricity consuming device, the output voltage thereof can be simply set to a fixed value.

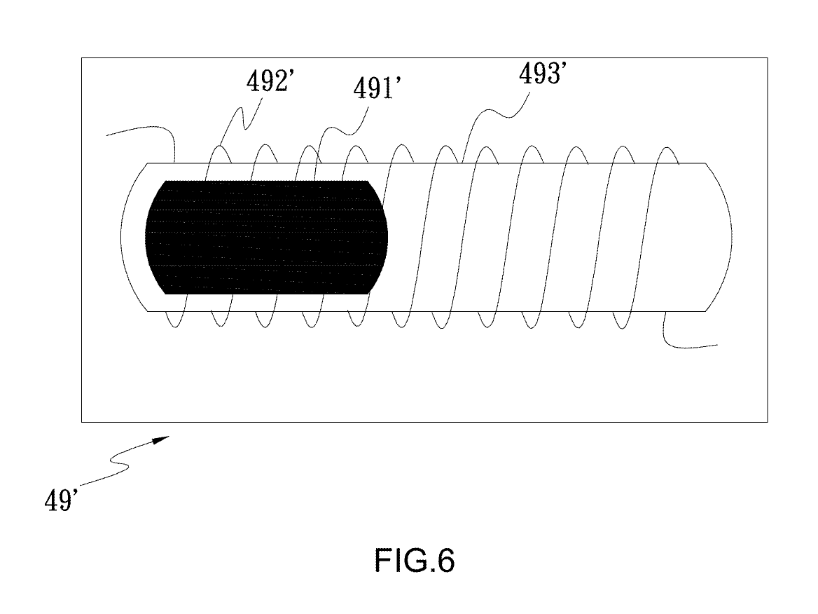

The third preferred embodiment of the invention is illustrated in FIG. 6, where a power converter according to the invention is provided with a micro power generator 49′ whose stator is configured in the form of a hollow cylinder 493′ fixed to the housing and wound with a coil set 492′, while the rotor thereof is in the form of a permanent magnet 491′ that is located within the hollow cylinder 493′ and is reciprocally movable along the coil direction. When a user is intended to wake up the power converter from a suspend mode, he can simply shake the power converter with hands to generate an external mechanical signal, so that the permanent magnet rotor 491′ of the micro power generator 49′ is moved with respect to the coil set 492′ to generate a small amount of electricity. As a result, a wake-up signal is generated for bringing the power converter back to a normal operating mode which allows a normal power supplying operation to carry out.

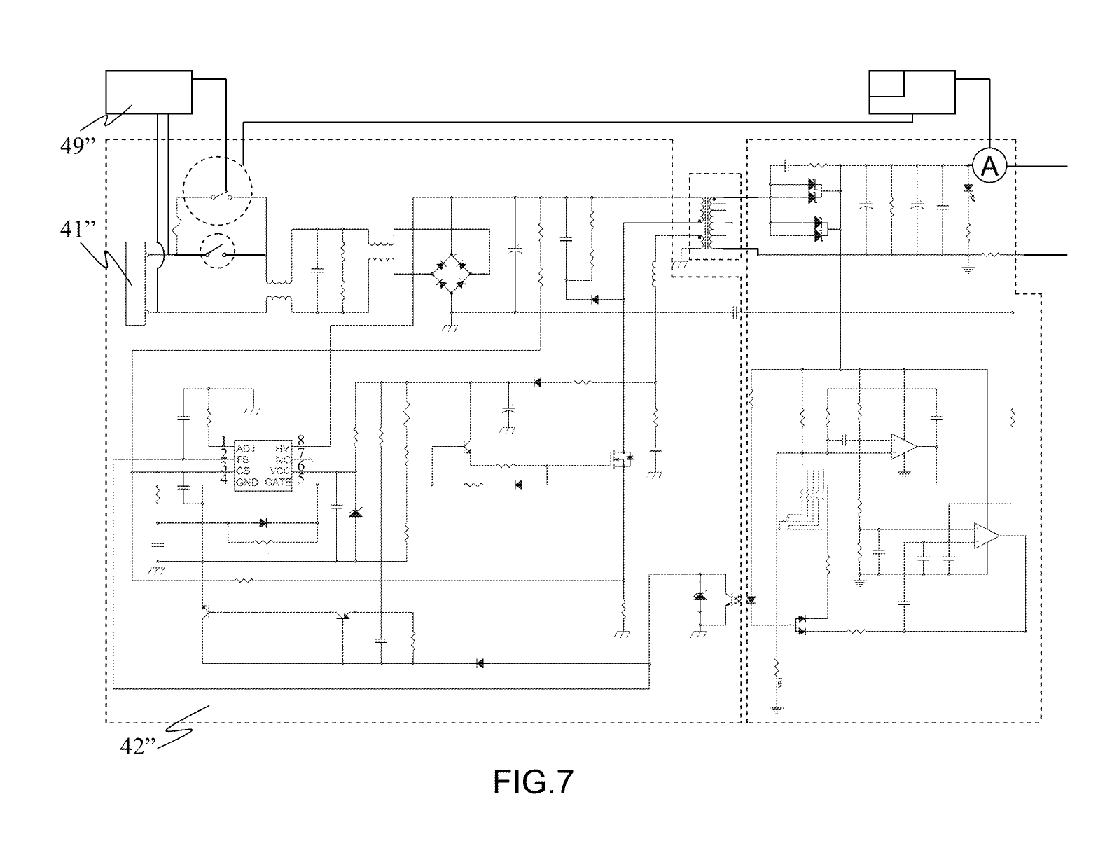

In addition, the wake-up unit is not limited to a micro power generator. According to the fourth preferred embodiment shown in FIG. 7, the wake-up unit may by way of example be a three-dimensional orientation sensor 49″ electrically connected to an input port 41″ and powered by an incoming voltage. Therefore, a user can recover the power converter from a suspend mode to a normal operating mode by slightly tipping or kicking the power converter. The external mechanical signal thus generated causes the three-dimensional orientation sensor 49″ to detect a three-dimensional disturbance, thereby activating a primary side circuit 42″.

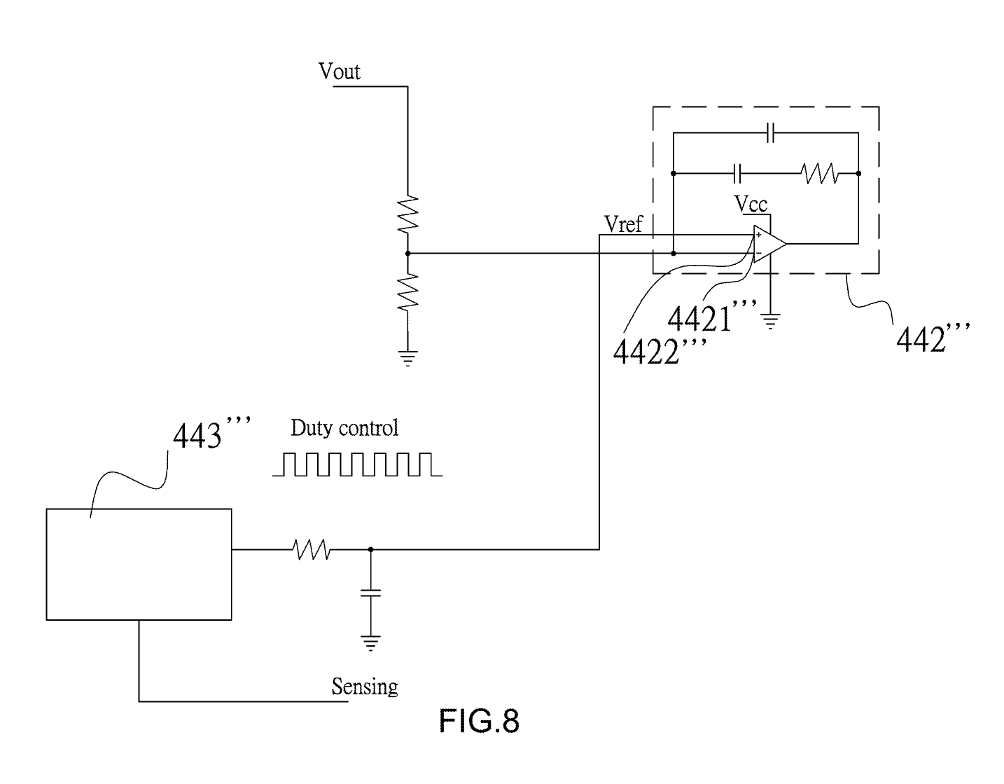

According to the fifth preferred embodiment shown in FIG. 8, in the case where the power converter is adjustable to provide a variety of output voltages, the voltage may be modulated by adjusting the duty-cycle ratio. The voltage-transforming unit includes an amplifier 442′″ having an inverting input terminal 4421′″, a non-inverting input terminal 4422′″ and an output terminal connected to the inverting input terminal 4421′″ to form a feedback loop. The voltage-transforming unit further includes a pulse-width modulation output terminal 443′″ for outputting a compensated PWM signal with a variable duty-cycle ratio to the amplifier 442′″. For example,

20V×high level 95%+0V×low level 0.05%=19V;

20V×high level 90%+0V×low level 0.10%=18V;

20V×high level 75%+0V×low level 0.25%=15V; and

20V×high level 60%+0V×low level 0.4%=12V.

The voltage may therefore be changed by adjustment of the duty-cycle ratio.

According to the foregoing disclosure, the inventive energy-saving power converter, in contrast to the prior art, can discontinue the voltage conversion when it need not supply power, thereby achieving the energy-saving and carbon reduction purposes. Meanwhile, the energy-saving power converter has a suspend mode to prevent excessive running, thereby prolonging the product lifespan. The energy-saving function of the power converter can be switched ON or OFF according to user's choice.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. An energy-saving power converter having a suspend mode for providing electric power to an electricity consuming device having at least two electricity consuming modes, including a working mode and a non-working mode, wherein the power converter has a suspend mode corresponding to the non-working mode of the electricity consuming device and a normal operating mode corresponding to the working mode of the electricity consuming device, the power converter comprising:
an output port for being electrically connected to the electricity consuming device;
a voltage-transforming unit having a controller and adapted for outputting at least one predetermined output voltage via the output port;
a processing unit including:
a sensor to be powered by the voltage-transforming unit and adapted for detecting the electric power to be output via the output port to assess the electricity consuming mode of the electricity consuming device, thereby deactivating the voltage-transforming unit; and
a switch for selectively determining whether or not the sensor is to be powered; and
a wake-up unit for activating the deactivated voltage-transforming unit upon receipt of a mechanical powering signal derived from outside of the power converter.

2. The power converter according to claim 1, wherein the voltage-transforming unit comprises transforming circuits for selecting one out of a plurality of predetermined different output voltages and transmitting the selected output voltage to the output port.

3. The power converter according to claim 1, further comprising an input port for receiving an input voltage and transmitting the input voltage to the voltage-transforming unit, at which the input voltage is converted into the least one predetermined output voltage.

4. The power converter according to claim 3, wherein the voltage-transforming unit comprises transforming circuits for converting an input voltage fed to the input port into one of a plurality of predetermined different output voltages to be transmitted to the output port, and a selector for selectively placing one of the transforming circuits in an electrically connected state.

5. The power converter according to claim 3, wherein the voltage-transforming unit comprises an amplifier having an inverting input terminal, a non-inverting input terminal and an output terminal connected to the inverting input terminal to form a feedback loop, and wherein the voltage-transforming unit further comprises a pulse-width modulation output terminal for outputting a compensated pulse-width modulation signal with a variable duty-cycle ratio to the amplifier.

6. The power converter according to claim 3, wherein the wake-up unit is electrically connected to the input port and powered by the input voltage.

7. The power converter according to claim 6, wherein the wake-up unit comprises an actuation sensor.

8. The power converter according to claim 1, wherein the wake-up unit comprises a micro power generator.

9. The power converter according to claim 1, wherein the processing unit further comprises a memory device, in which a predetermined threshold value for the electricity consuming mode is stored and serves as a standard for the assessment of the electricity consuming mode of the electricity consuming device by the sensor when the sensor is powered.
